(19) United States
(12) Patent Application Publication
(10) Pub. No.: US 2023/0152284 A1
(43) Pub. Date: May 18, 2023

(54) METHOD OF QUANTITATIVELY ANALYZING 11 AMIDE ALKALOIDS IN TOBACCO LEAVES USING GAS CHROMATOGRAPHY-TANDEM MASS SPECTROMETRY

(71) Applicant: Yunnan Academy of Tobacco Agricultural Sciences, Kunming City (CN)

(72) Inventors: Xiaopeng DENG, Kunming City (CN); Junli SHI, Kunming City (CN); Tao PANG, Kunming City (CN); Yong LI, Kunming City (CN)

(21) Appl. No.: 17/844,859

(22) Filed: Jun. 21, 2022

(30) Foreign Application Priority Data
Nov. 16, 2021 (CN) 202111354481.2

(51) Int. Cl. G01N 30/72; G01N 30/06

(52) U.S. Cl. CPC G01N 30/7206; G01N 30/06; G01N 2030/062; G01N 2030/025

(57) ABSTRACT

A method for quantitatively analyzing 11 amide alkaloids in tobacco leaves using gas chromatography-tandem mass spectrometry, comprises: soaking with a sodium hydroxide solution so as to free amide alkaloids from a tobacco powder sample matrix, transferring target compounds into an ether layer through extraction with methyl tertiary butyl ether, concentrating methyl tertiary butyl ether extraction liquids for analysis with gas chromatography-tandem mass spectrometry, inputting chromatographic peak areas obtained by an instrument into standard calibration curve fitting equations of the corresponding amide alkaloids to obtain the concentrations of the corresponding target compounds, and converting the concentrations to obtain the contents of the corresponding amide alkaloids in the tobacco leaves. The method can quantitatively analyze the 11 amide alkaloids at the same time, and has the advantages of simpleness, rapidness, stability and the like.

### TECHNICAL FIELD

The present invention belongs to the technical field of analytical chemistry and particularly relates to a method for simultaneously and quantitatively analyzing 11 amide alkaloids in tobacco leaves based on gas chromatography-tandem mass spectrometry and a tobacco leaf analysis method.

### BACKGROUND

As the safety and the quality of tobacco leaves are closely related to health of humans, people have paid more and more attention to research on various components in tobaccos. However, chemical reactions in production processing and storage of the tobaccos are relatively complex, changes of chemical substances in the chemical reactions are complex and diversified, and therefore, many components are not clearly understood. At present, a compound amide alkaloid related to demethylated nicotine in the tobaccos have been discovered in research, however, the quantitative analysis method and applications of the amide alkaloids have not been developed yet.

### SUMMARY

In order to solve the above technical problems, the present invention provides a method for quantitatively analyzing 11 amide alkaloids in tobacco leaves using gas chromatography-tandem mass spectrometry, comprising: soaking with a sodium hydroxide solution so as to free amide alkaloids from a sample matrix, transferring target compounds into an ether layer through extraction with methyl tertiary butyl ether, concentrating a methyl tertiary butyl ether layer for analysis with gas chromatography-tandem mass spectrometry to determine the contents of the 11 amide alkaloids in the tobacco leaves at the same time, and then analyzing the tobacco leaves based on the contents of the amide alkaloids.

The technical solution of the present invention is as follows:

Disclosed is a method for quantitatively analyzing 11 amide alkaloids in tobacco leaves using gas chromatography-tandem mass spectrometry, comprising: soaking with a sodium hydroxide solution so as to free amide alkaloids from a tobacco powder sample matrix, transferring target compounds into an ether layer through extraction with methyl tertiary butyl ether, concentrating methyl tertiary butyl ether extraction liquids for analysis with gas chromatography-tandem mass spectrometry, inputting chromatographic peak areas obtained by an instrument into standard calibration curve fitting equations of the corresponding amide alkaloids to obtain the concentrations of the corresponding target compounds, and converting the concentrations to obtain the contents of the corresponding amide alkaloids in the tobacco leaf.

Preferably, the method comprises the following steps:

S1, pretreating a sample: soaking with the sodium hydroxide solution so as to release the amide alkaloids in the tobacco powder sample matrix, extracting the released amide alkaloids with the methyl tertiary butyl ether for many times, and concentrating the methyl tertiary butyl ether extraction liquids so that the target amide alkaloids can be detected by the instrument;

S2, determining instrument analysis conditions, including chromatographic conditions and mass spectrometry conditions; and

S3, conducting quantification by using standard curves, drawing standard calibration curve fitting equations and linearly dependent coefficients of the 11 amide alkaloids, analyzing concentrated solutions of the methyl tertiary butyl ether extraction liquids in S1 with gas chromatography-tandem mass spectrometry according to the conditions in S2 to obtain the chromatographic peak areas of the amide alkaloids contained in an actual tobacco leaf sample, inputting the chromatographic peak areas into the corresponding standard calibration curve fitting equations to obtain the concentrations of the corresponding target compounds, and converting the concentrations to obtain the contents of the corresponding amide alkaloids in the tobacco leaves.

Further preferably, the standard calibration curve fitting equations and the linearly dependent coefficients are obtained in the following mode:

S31, preparing the standard solutions: preparing gradient concentrations of working solutions of the 11 amide alkaloids with a solvent methyl tertiary butyl ether;

S32, analyzing with gas chromatography-tandem mass spectrometry according to the conditions set in S2 to obtain a chromatographic-mass spectrum peak area corresponding to each concentration gradient sample, and conducting linear fitting on the obtained peak areas and the corresponding concentration gradients to obtain the standard calibration curve fitting equations and the linearly dependent coefficients.

Preferably, the S3 specifically comprises the following steps:

S31, preparing standard solutions: preparing gradient concentrations of working solutions of the 11 amide alkaloids with a solvent methyl tertiary butyl ether;

S32, analyzing with gas chromatography-tandem mass spectrometry according to the conditions set in S2 to obtain the chromatographic-mass spectrum peak area corresponding to each concentration gradient sample, and conducting linear fitting on the obtained peak areas and the corresponding concentration gradients to obtain the standard calibration curve fitting equations and the linearly dependent coefficients;

S33, analyzing the concentrated solution of the methyl tertiary butyl ether extraction liquids in S1 with gas chromatography-tandem mass spectrometry according to the conditions in S2 to obtain the chromatographic peak areas of the amide alkaloids contained in the actual tobacco leaf sample, and inputting the chromatographic peak areas into the corresponding standard calibration curve fitting equations to obtain corresponding substance concentrations (μg/mL); and

S34, converting the concentrations through equation (1) to obtain the contents of the corresponding amide alkaloids in the tobacco leaves:

X=c/5 (1)

in the equation, X represents the content of each of the 11 amide alkaloids in the sample with a unit of μg/g; and c represents the concentration of each detected component obtained by the corresponding standard curve, with a unit of μg/mL.

Preferably, in the S1, the weight of the tobacco powder sample is 4-6 g; the dosage of the sodium hydroxide solution is 18-22 mL; the concentration of the sodium hydroxide solution is 2-8%; the dosage of the methyl tertiary butyl ether is 8-12 mL; and after layering via standing, 1 mL of supernatant liquid is pipetted to a 2 mL gas chromatography injecting vial.

Further preferably, the tobacco leaf sample is dried, crushed and sieved firstly to obtain the tobacco powder sample, wherein a drying temperature is 30-50° C., and a sieving size is 30-60 meshes.

Preferably, in the S2, the determined instrument analysis conditions are as follows:

chromatographic conditions: chromatographic column: DB-5 MS, 30 m×0.25 mm×0.25 μm; injection volume: 1 μL; split ratio: 20:1; injection port temperature: 250° C.; temperature program conditions: starting from 100° C., a temperature is raised to 300° C. at 10° C./min and then kept for 5 min.

Mass spectrometry conditions: temperature of a transmission line: 260° C.; temperature of an ion source: 230° C.; ionization mode: electron impact ionization, 70 eV; filament current: 50 μA; voltage of an electron multiplier: 1200 V; collision gas: argon with a purity larger than or equal to 99.999%; pressure of a collision cell: 0.3 Pa; solvent delay time: 4 min; data acquisition mode: multiple reaction monitoring.

Disclosed is a tobacco leaf analysis method, comprising the following steps: selecting different tobacco leaf samples, quantitatively analyzing the contents of amide alkaloids in tobacco leaves, and establishing a database according to correspondence between samples with the same amide alkaloid content and flavors of specific tobacco leaves, wherein the quantitatively analyzing employs the aforementioned method.

The present invention has the following beneficial technical effects that:

According to the method for quantitatively analyzing the 11 amide alkaloids in the tobacco leaves using gas chromatography-tandem mass spectrometry, a method for simultaneously and quantitatively analyzing the 11 amide alkaloids is established through pretreatment of tobacco leaves and optimization of conditions of gas chromatography-tandem mass spectrometry, which has the advantages of simpleness, rapidness, stability and the like and fills in the gap that there are no methods for quantitatively analyzing the 11 amide alkaloids in the tobacco leaves at present.

Further, a secondary amine nitrogen atom in nornicotine (also called demethylated nicotine) has certain activity and is easily bonded to organic acids to form the amide alkaloids. As nitrosonornicotine (NNN) having carcinogenicity is also derived from the nornicotine, that is, the generation of the amide alkaloids consumes the content of the demethylated nicotine in the tobacco leaves, and therefore the content of the NNN can be further analyzed through quantitative analysis of the amide alkaloids in the present invention. In another aspect, it is found via researches that the formed amide alkaloids can further affect the style characteristic of the tobacco leaves. Therefore, a corresponding database of the amide alkaloids and the flavors can be established by analyzing the flavors of the tobacco leaves with the same content of the amide alkaloids, which plays a reference role in selection of raw materials and setting in production processes. Thus, the acylation product of the demethylated nicotine in the tobacco leaves can be accurately quantified in the present invention, which is great significance for evaluating the safety and the quality of the tobacco leaves and conducting related metabolic research on nicotine.

### BRIEF DESCRIPTION OF THE DRAWINGS

FIG. 1 is a diagram showing chemical structures of 11 amide alkaloids.

FIG. 2 is a gas chromatography-tandem mass spectrometry chromatogram of 11 amide alkaloids.

Reference numerals: 1—N′-formylnornicotine; 2—N′-acetylnornicotine; 3—N′-propionylnornicotine; 4—N′-n-butyrylnornicotine; 5—N′-n-pentanoylnornicotine; 6—N′-n-hexanoylnornicotine; 7—N′-n-heptanoylnornicotine; 8—N′-n-octanoylnornicotine; 9—N′-n-nonanoylnornicotine; 10—N′-n-decanoylnornicotine; 11—N′-n-undecanoylnornicotine.

### DETAILED DESCRIPTION OF THE EMBODIMENTS

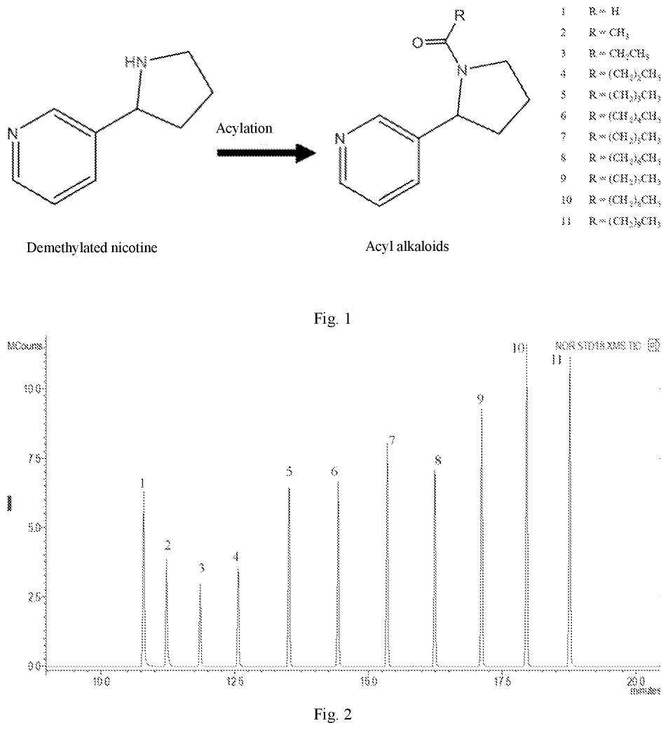

For convenience in understanding the technical solutions of the present application, detailed description will be made below through specific embodiments in combination with FIGS. 1-2.

Instruments and reagents used in example 1 and example 2 are as follows:

Gas chromatography-tandem mass spectrometer (Bruker Company, America); Millipore ultrapure water machine (Millipore Company, America); Eppendoff 5804 high-speed centrifuge (Eppendoff Company, Germany); Talboys digital multi-tube vortex mixer (Troemner Company, America).

Experiment reagents: leaves of “vermilion tobaccos” passing determination of appearance characteristics after being flue-cured and ordinary flue-cured tobaccos; sodium hydroxide (analytically pure, Shantou Xilong chemical plant in Guangdong Province); methyl tertiary butyl ether (chromatographically pure, Beijing J&K Chemicals Biological Co., Ltd.).

### Example 1

This example discloses a method for simultaneously and quantitatively analyzing 11 amide alkaloids in vermilion tobacco leaves using gas chromatography-tandem mass spectrometry. The chemical structures of the 11 amide alkaloids are shown in FIG. 1.

Experimental Steps:

S1, pretreatment of a sample: amide alkaloids contained in a to-be-analyzed tobacco leaf sample were extracted.

A vermilion tobacco leaf sample was dried at 40° C., crushed and screened with a 40-mesh sieve for future detection. 5.00 g of powder sample was accurately weighed and put in a 50 mL centrifuge tube, 20 mL of 5% NaOH solution was added, the centrifuge tube was subjected to vortex vibration for 1 min, and standing for 10 min, 10 mL of methyl tertiary butyl ether was added for liquid-liquid extraction, and 1 mL of supernatant was pipetted to a 2 mL gas chromatography injecting vial after layering via standing to be analyzed via a gas chromatography-mass spectrometer.

S2, determination of instrument analysis conditions

Chromatographic conditions: chromatographic column: DB-5 MS (30 m×0.25 mm×0.25 μm); injection volume: 1 μL; split ratio: 20:1; injection port temperature: 250° C.; temperature program conditions: starting from 100° C., a temperature was raised to 300° C. at 10° C./min and then kept for 5 min.

Conditions of quantitative analysis with mass spectrometry: temperature of a transmission line: 260° C.; temperature of an ion source: 230° C.; ionization mode: electron impact (EI) ionization, 70 eV; filament current: 50 μA; voltage of an electron multiplier: 1200 V; collision gas: argon (with a purity larger than or equal to 99.999%); pressure of a collision cell: 0.3 Pa; solvent delay time: 4 min; data acquisition mode: multiple reaction monitoring (MRM). Acquisition parameters of specific compounds are seen in Table 1. A total ion chromatogram of 11 acyl metabolites of demethylated nicotine is shown as FIG. 2. In the drawing, 1-11 represents: 1, N′-formylnornicotine; 2, N′-acetylnornicotine; 3, N′-propionylnornicotine; 4, N′-n-butyrylnornicotine; 5, N′-n-pentanoylnornicotine; 6, N′-n-hexanoylnornicotine; 7, N′-n-heptanoylnornicotine; 8, N′-n-octanoylnornicotine; 9, N′-n-nonanoylnornicotine; 10, N′-n-decanoylnornicotine; 11, N′-n-undecanoylnornicotine.

TABLE 1
MRM Ion Parameters of Acyl Metabolites
of Demethylated Nicotine

| | Retention | Parent ion-−> | Collision | Dwell |
|---|---|---|---|---|
| Compound | Time (min) | daughter ion | energy (V) | time (s) |
| N′-formylnor- | 10.91 | 119-−>92 | 13 | 0.15 |
| nicotine | | 176-−>147 | 11 | 0.15 |
| N′-acetylnor- | 11.28 | 120-−>105 | 13 | 0.15 |
| nicotine | | 190-−>147 | 11 | 0.15 |
| N′-propionylnor- | 12.15 | 175-−>147 | 15 | 0.15 |
| nicotine | | 204-−>147 | 11 | 0.15 |
| N′-n-butyrylnor- | 12.58 | 175-−>147 | 13 | 0.15 |
| nicotine | | 218-−>147 | 11 | 0.15 |
| N′-n-pentanoylnor- | 13.83 | 175-−>147 | 15 | 0.15 |
| nicotine | | 232-−>147 | 11 | 0.15 |
| N′-n-hexanoylnor- | 14.44 | 175-−>147 | 15 | 0.15 |
| nicotine | | 246-−>147 | 11 | 0.15 |
| N′-n-heptanoylnor- | 15.35 | 175-−>147 | 19 | 0.15 |
| nicotine | | 260-−>147 | 11 | 0.15 |
| N′-n-octanoylnor- | 16.25 | 175-−>147 | 15 | 0.15 |
| nicotine | | 274-−>147 | 11 | 0.15 |
| N′-n-nonanoylnor- | 17.12 | 175-−>147 | 17 | 0.15 |
| nicotine | | 288-−>147 | 11 | 0.15 |
| N′-n-decanoylnor- | 18.17 | 175-−>147 | 15 | 0.15 |
| nicotine | | 302-−>147 | 11 | 0.15 |
| N′-n-undecanoylnor- | 18.75 | 175-−>147 | 17 | 0.15 |
| nicotine | | 316-−>147 | 11 | 0.15 |

S3, quantification via standard curves:

S31, preparation of standard solutions: gradient concentrations of working solutions of the 11 amide alkaloids were prepared with a solvent methyl tertiary butyl ether.

100.0 mg of 11 amide alkaloids were accurately weighed and put in different 100 mL volumetric flasks, methyl tertiary butyl ether was added to make solutions into a fixed volume so as to prepare 1 mg/mL single-standard stock solutions, and the single-standard stock solutions were preserved in dark at −20° C. According to the actual conditions of the samples, the single-standard stock solutions were diluted to gradient concentrations of working solutions for drawing quantitative standard curves.

S32, drawing of quantitative standard curves: different concentration gradients of prepared standard samples of various amide alkaloids were analyzed according to the method in the portion “Instrument Analysis Conditions” to obtain a chromatographic-mass spectrum peak area corresponding to each concentration gradient sample. Linear fitting was conducted on each obtained peak area and its corresponding concentration gradient to obtain the corresponding standard calibration curve fitting equation and the corresponding linearly dependent coefficients of each amide alkaloid. Results are shown in Table 2.

TABLE 2
Quantitative Calibration Curves for 11 Acyl Metabolites of Demethylated
Micotine as well as Detection Limits and Quantification Limits

| | | | Detection | Quantification |
|---|---|---|---|---|
| | | | limit | limit |
| Compound | Standard curve | R² | (μg/g) | (μg/g) |
| N′-formylnornicotine | y = 38701x-2000000 | 0.9958 | 2.0 | 4.0 |
| N′-acetylnornicotine | y = 19044x-759883 | 0.9965 | 1.3 | 3.9 |
| N′-propionylnornicotine | y = 16486x-606995 | 0.9965 | 1.7 | 3.4 |
| N′-n-butyrylnornicotine | y = 30091x-570512 | 0.9980 | 0.9 | 1.8 |
| N′-n-pentanoylnornicotine | y = 10207x-277931 | 0.9979 | 1.2 | 2.4 |
| N′-n-hexanoylnornicotine | y = 12750x-259779 | 0.9990 | 1.3 | 2.6 |
| N′-n-heptanoylnornicotine | y = 14588x-311625 | 0.9992 | 1.4 | 2.8 |
| N′-n-octanoylnornicotine | y = 58472x-928393 | 0.9954 | 1.8 | 3.6 |
| N′-n-nonanoylnornicotine | y = 63399x-1000000 | 0.9964 | 0.3 | 1.0 |
| N′n-decanoylnornicotine | y = 60718x-987639 | 0.9960 | 0.8 | 1.6 |
| N′-n-undecanoylnornicotine | y = 68282x-1000000 | 0.9965 | 1.5 | 3.0 |

S33, analysis of an actual tobacco leaf sample: 1 mL of concentrated solution of a methyl tertiary butyl ether extraction liquid of an actual sample was transferred into a 2 mL gas chromatography sampling vial and was analyzed via a gas chromatography-tandem mass spectrometer. Obtained chromatographic peak areas of the 11 amide alkaloids in the actual sample were input into the calibration curve equations to be calculated so as to obtain corresponding substance concentrations (μg/mL).

S34, the contents of the 11 amide alkaloids in the tobacco leaves were calculated according to equation (1):

X=c/5 (1)

in the equation, X represents the content of each of the 11 amide alkaloids in the sample with a unit of μg/g; and c represents the concentration of each detected component obtained by the corresponding standard curve, with a unit of μg/mL.

The contents of the 11 amide alkaloids in the vermilion tobaccos were calculated, as shown in Table 3 below.

### Example 2

This example discloses a method for simultaneously and quantitatively analyzing 11 amide alkaloids in ordinary flue-cured tobacco leaves using gas chromatography-tandem mass spectrometry. The experimental steps are the same as those in example 1.

The contents of the 11 amide alkaloids in the ordinary flue-cured tobaccos were calculated, as shown in Table 3.

TABLE 3
Distribution Condition of Contents of 11 Acyl
Metabolites of Demethylated Nicotine in Vermilion
Tobaccos and Normal Flue-Cured Tobaccos

| | Normal flue-cured | Vermilion |
|---|---|---|
| Compound | tobacco | tobacco |
| N′-formylnornicotine | 8.3 ± 0.62 | 19.37 ± 1.01 |
| N′-acetylnornicotine | 6.19 ± 0.5 | 11.99 ± 0.65 |
| N′-propionylnornicotine | 3.99 ± 0.37 | 3.83 ± 0.21 |
| N′-n-butyrylnornicotine | 1.94 ± 0.19 | 4.35 ± 0.23 |
| N′-n-pentanoylnornicotine | Non detected | 1.21 ± 0.31 |
| N′-n-hexanoylnornicotine | 4.21 ± 0.34 | 37.86 ± 1.91 |
| N′-n-heptanoylnornicotine | 4.4 ± 0.36 | 7.32 ± 0.48 |
| N′-n-octanoylnornicotine | 12.36 ± 0.8 | 144.46 ± 4.25 |
| N′-n-nonanoylnornicotine | Non detected | 1.66 ± 0.09 |
| N′-n-decanoylnornicotine | 3.46 ± 0.25 | 5.91 ± 0.3 |
| N′-n-undecanoylnornicotine | Non detected | 3.49 ± 0.26 |
| Total content | 44.85 ± 3.43 | 240.24 ± 9.39 |

It can be seen from Table 3 that the contents of the acyl metabolites of the demethylated nicotine in the vermilion tobaccos are significantly increased compared with those of the normal flue-cured tobaccos, wherein the contents of N′-n-octanoylnornicotine and N′-n-hexanoylnornicotine are maximally raised.

### Example 3

For tobacco leaves in the same batch, after the tobacco leaves were subjected to different processing methods or under different storage conditions, the contents of the amide alkaloids were quantitatively analyzed by employing the methods in the above-mentioned examples. The higher the contents are, the more it indicates that the processing methods or the storage conditions promote conversion of nornicotine to the amide alkaloids. Therefore, the method can be used for assisting selection of suitable processing methods or storage conditions.

### Example 4

Tobacco leaf samples from different production plates or subjected to different agronomic treatments were selected, and the contents of the amide alkaloids in the tobacco leaves were quantitatively analyzed.

A database was correspondingly established according to the samples with the same amide alkaloid content and flavors of specific tobacco leaves.

For example, when data of test on certain tobacco leaves is shown in the right column in Table 3, the tobacco leaves are suitable to be processed into a tobacco with a vermillion flavor.

The contents of the alkaloids required to be determined only in the following, that is, the flavor is determined through the database, without manual screening.

The representative examples of the present invention are described in detail above, but the present invention is not limited to those details in the above examples. Various simple variations can be made on the technical solution of the present invention within the range of concept of the present invention; and all changes and combinations apparent to those skilled in the art are included within the protective scope of the present invention.

What is claimed is:

1. A method for quantitatively analyzing 11 amide alkaloids in tobacco leaves by using gas chromatography-tandem mass spectrometry, comprising: soaking with a sodium hydroxide solution so as to free amide alkaloids from a tobacco powder sample matrix, transferring target compounds into an ether layer through extraction with methyl tertiary butyl ether, concentrating methyl tertiary butyl ether extraction liquids for analysis with gas chromatography-tandem mass spectrometry, inputting chromatographic peak areas obtained by an instrument into standard calibration curve fitting equations of the corresponding amide alkaloids to obtain the concentrations of the corresponding target compounds, and converting the concentrations to obtain the contents of the corresponding amide alkaloids in the tobacco leaves.

2. The method according to claim 1, comprising the following steps:
S1, pretreating a sample: soaking with the sodium hydroxide solution so as to release the amide alkaloids in the tobacco powder sample matrix, extracting the released amide alkaloids with methyl tertiary butyl ether for multiple times, and concentrating the methyl tertiary butyl ether extraction liquids so that the target amide alkaloids can be detected by the instrument;
S2, determining instrument analysis conditions including chromatographic conditions and mass spectrometry conditions; and
S3, conducting quantification by using a standard curve, drawing standard calibration curve fitting equations and linearly dependent coefficients of 11 amide alkaloids, analyzing the concentrated solutions of the methyl tertiary butyl ether extraction liquids in S1 with gas chromatography-tandem mass spectrometry according to the conditions in S2 to obtain the chromatographic peak areas of the amide alkaloids contained in an actual tobacco leaf sample, inputting the chromatographic peak areas into the corresponding standard calibration curve fitting equations to obtain the concentrations of the corresponding target compounds, and converting the concentrations to obtain the contents of the corresponding amide alkaloids in the tobacco leaves.

3. The method according to claim 2, wherein the standard calibration curve fitting equations and the linearly dependent coefficients are obtained in the following mode:
S31, preparing standard solutions: preparing gradient concentrations of working solutions of 11 amide alkaloids with a solvent which is methyl tertiary butyl ether; and
S32, analyzing with gas chromatography-tandem mass spectrometry according to the conditions set in S2 to obtain a chromatographic-mass spectrum peak area corresponding to each concentration gradient sample, and conducting linear fitting on the obtained peak areas and the corresponding concentration gradients to obtain the standard calibration curve fitting equations and the linearly dependent coefficients.

4. The method according to claim 3, wherein the S3 specifically comprises the following steps:
S31, preparing standard solutions: preparing gradient concentrations of working solutions of the 11 amide alkaloids with a solvent which is methyl tertiary butyl ether;
S32, analyzing with gas chromatography-tandem mass spectrometry according to the conditions set in S2 to obtain the chromatographic-mass spectrum peak area corresponding to each concentration gradient sample, and conducting linear fitting on the obtained peak areas and the corresponding concentration gradients to obtain the standard calibration curve fitting equations and the linearly dependent coefficients;
S33, analyzing the concentrated solution of the methyl tertiary butyl ether extraction liquid in S1 with gas chromatography-tandem mass spectrometry according to the conditions in S2 to obtain the chromatographic peak areas of the amide alkaloids contained in the actual tobacco leaf sample, and inputting the chromatographic peak areas into the corresponding standard calibration curve fitting equations to obtain corresponding substance concentrations (μg/mL); and
S34, converting the concentrations through equation (1) to obtain the contents of the corresponding amide alkaloids in the tobacco leaves:
X=c/5 (1)
in the equation, X represents the content of each of the 11 amide alkaloids in the sample with a unit of μg/g; and c represents the concentration of each detected component obtained by the corresponding standard curve, with a unit of μg/mL.

5. The method according to claim 2, wherein the S3 specifically comprises the following steps:
S31, preparing standard solutions: preparing gradient concentrations of working solutions of the 11 amide alkaloids with a solvent which is methyl tertiary butyl ether;
S32, analyzing with gas chromatography-tandem mass spectrometry according to the conditions set in S2 to obtain the chromatographic-mass spectrum peak area corresponding to each concentration gradient sample, and conducting linear fitting on the obtained peak areas and the corresponding concentration gradients to obtain the standard calibration curve fitting equations and the linearly dependent coefficients;
S33, analyzing the concentrated solution of the methyl tertiary butyl ether extraction liquid in S1 with gas chromatography-tandem mass spectrometry according to the conditions in S2 to obtain the chromatographic peak areas of the amide alkaloids contained in the actual tobacco leaf sample, and inputting the chromatographic peak areas into the corresponding standard calibration curve fitting equations to obtain corresponding substance concentrations (μg/mL); and
S34, converting the concentrations through equation (1) to obtain the contents of the corresponding amide alkaloids in the tobacco leaves:
X=c/5 (1)
in the equation, X represents the content of each of the 11 amide alkaloids in the sample with a unit of μg/g; and c represents the concentration of each detected component obtained by the corresponding standard curve, with a unit of μg/mL.

6. The method according to claim 2, wherein in the S1, the weight of the tobacco powder sample is 4-6 g; the dosage of the sodium hydroxide solution is 18-22 mL; the concentration of the sodium hydroxide solution is 2-8%; the dosage of the methyl tertiary butyl ether is 8-12 mL; and after layering via standing, 1 mL of supernatant is pipetted to a 2 mL gas chromatography injecting vial.

7. The method according to claim 6, wherein the tobacco leaf sample is dried, crushed and sieved firstly to obtain the tobacco powder sample, wherein a drying temperature is 30-50° C., and a sieving size is 30-60 meshes.

8. The method according to claim 2, wherein in the S2, the determined instrument analysis conditions are as follows:
chromatographic conditions: chromatographic column: DB-5 MS, 30 m×0.25 mm×0.25 μm; injection volume: 1 μL; split ratio: 20:1; injection port temperature: 250° C.; temperature program conditions: starting from 100° C., a temperature is raised to 300° C. at 10° C./min and then kept for 5 min; and
mass spectrometry conditions: temperature of a transmission line: 260° C.; temperature of an ion source: 230° C.; ionization mode: electron impact ionization, 70 eV; filament current: 50 μA; voltage of an electron multiplier: 1200 V; collision gas: argon with a purity larger than or equal to 99.999%; pressure of a collision cell: 0.3 Pa; solvent delay time: 4 min; data acquisition mode: multiple reaction monitoring.

9. A tobacco leaf analysis method, comprising the following steps: selecting different tobacco leaf samples, quantitatively analyzing the contents of amide alkaloids in tobacco leaves, and establishing a database according to a correspondence between samples with the same amide alkaloid content and flavors of specific tobacco leaves, wherein the quantitatively analyzing employs the method according to claim 1.

10. A tobacco leaf analysis method, comprising the following steps: selecting different tobacco leaf samples, quantitatively analyzing the contents of amide alkaloids in tobacco leaves, and establishing a database according to a correspondence between samples with the same amide alkaloid content and flavors of specific tobacco leaves, wherein the quantitatively analyzing employs the method according to claim 2.

11. A tobacco leaf analysis method, comprising the following steps: selecting different tobacco leaf samples, quantitatively analyzing the contents of amide alkaloids in tobacco leaves, and establishing a database according to a correspondence between samples with the same amide alkaloid content and flavors of specific tobacco leaves, wherein the quantitatively analyzing employs the method according to claim 3.

12. A tobacco leaf analysis method, comprising the following steps: selecting different tobacco leaf samples, quantitatively analyzing the contents of amide alkaloids in tobacco leaves, and establishing a database according to a correspondence between samples with the same amide alkaloid content and flavors of specific tobacco leaves, wherein the quantitatively analyzing employs the method according to claim 4.

13. A tobacco leaf analysis method, comprising the following steps: selecting different tobacco leaf samples, quantitatively analyzing the contents of amide alkaloids in tobacco leaves, and establishing a database according to a correspondence between samples with the same amide alkaloid content and flavors of specific tobacco leaves, wherein the quantitatively analyzing employs the method according to claim 5.

14. A tobacco leaf analysis method, comprising the following steps: selecting different tobacco leaf samples, quantitatively analyzing the contents of amide alkaloids in tobacco leaves, and establishing a database according to a correspondence between samples with the same amide alkaloid content and flavors of specific tobacco leaves, wherein the quantitatively analyzing employs the method according to claim 6.

15. A tobacco leaf analysis method, comprising the following steps: selecting different tobacco leaf samples, quantitatively analyzing the contents of amide alkaloids in tobacco leaves, and establishing a database according to a correspondence between samples with the same amide alkaloid content and flavors of specific tobacco leaves, wherein the quantitatively analyzing employs the method according to claim 7.

16. A tobacco leaf analysis method, comprising the following steps: selecting different tobacco leaf samples, quantitatively analyzing the contents of amide alkaloids in tobacco leaves, and establishing a database according to a correspondence between samples with the same amide alkaloid content and flavors of specific tobacco leaves, wherein the quantitatively analyzing employs the method according to claim 8.
